(19) United States
(12) Patent Application Publication
(10) Pub. No.: US 2014/0185443 A1
(43) Pub. Date: Jul. 3, 2014

(54) DATA OPTIMIZATION TECHNIQUE FOR THE EXCHANGE OF DATA AT THE EDGE OF A WIRELESS LOCAL AREA NETWORK

(71) Applicant: FUTUREWEI TECHNOLOGIES, INC., Plano, TX (US)

(72) Inventors: Saeid Safavi, San Diego, CA (US); Shree Murthy, San Jose, CA (US)

(73) Assignee: FUTUREWEI TECHNOLOGIES, INC., Plano, TX (US)

(21) Appl. No.: 13/729,442

(22) Filed: Dec. 28, 2012

(51) Int. Cl. H04W 28/02

(52) U.S. Cl. CPC H04W 28/0247
USPC 370/235

(57) ABSTRACT

An apparatus for the transmission of management and/or control traffic in a network, comprising a memory configured to store a first record of management and/or control data from a previous interval, and a processor coupled to the memory, wherein the processor is configured to retrieve the first record, receive a second record of the network management and/or control data for a current interval, and generate a differential of the first and second records.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Wireless local area networks (WLANs) are becoming ubiquitous in both the business and home settings. Businesses, for example, are experiencing a large increase in the use of WLANs as their network structure of choice eschewing the need to tie work terminals to physical network connections. Businesses are also allowing their employees to bring personal wireless devices to access WLANs and guests are being allowed to access WLANs while on the premises. With the increase in the number of wireless devices using these WLANs, consumption of the wireless bandwidth (BW) increases.

WLANs, and networks in general, typically only have a limited amount of BW to be used by all connected devices. Thus, as the number of devices connected to a network increase, the amount of BW available for any one device typically decreases. Additionally, the applications being accessed over the network by these devices may require large amounts of BW, further reducing the amount of BW available to the network. Hence, with the increase in both the number of devices connected to a network and the BW hungry applications being used, the overall BW for the network may quickly be depleted causing the network to slow down or crash.

Networks, however, do not transmit only the data or information specific to user requests. Networks must also manage and control their operation and how connected devices interface with them. To perform the management and control of a network, then, requires another set of network traffic focused on the network's health and security. However, management and control traffic also consumes BW. Therefore, one way of preserving more BW for devices and applications may be to limit the amount of BW used for the management and/or control traffic.

### SUMMARY

In one embodiment, the disclosure includes an apparatus for the transmission of management and control traffic in a network, comprising a memory configured to store a first record of management and control data from a previous interval, and a processor coupled to the memory, wherein the processor is configured to retrieve the first record, receive a second record of the network management and control data for a current interval, and generate a differential of the first and second records.

In another embodiment, the disclosure includes a method for transmitting the management and control data in a network, comprising maintaining a record of management and control data of a network from a previous interval, producing a record of the management and control data from a current interval, generating a differential of the current and previous records; and transmitting the differential to a management and control module.

In yet another embodiment, the disclosure includes an apparatus for reducing redundancy in the transmission of management and control parameters of a network, comprising a processor configured to receive a first record of a management and control parameter, wherein the first record indicates a change in the parameter over a current time interval, and a memory coupled to the processor configured to store records.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a WLAN

FIG. 2 illustrates an embodiment of a WLAN access point (AP)

FIG. 3 illustrates an embodiment of a method for optimizing the transmission of network management and control data.

### DETAILED DESCRIPTION

It should be understood at the outset that, although an illustrative implementation of one or more embodiments are provided below, the disclosed systems and/or methods may he implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

WLANs may conventionally be used to link one or more devices with a wired network usually comprising servers and external connections to the Internet using some wireless distribution method. The connection between the wireless devices and the wired network may be provided through an AP. As used herein, a WLAN may also be referred to as a wireless network or a network. The wired portion may be referred to as the network's backbone and may include servers, databases, connections to the internet, and network control modules. The wireless portion of a network may refer to the wireless connection of user devices, which may include laptop computers, phones, other handheld devices, etc., to the network through an AP. A wireless connection may allow users to access servers and databases, a company intranet, and possibly the Internet through their devices. These types of networks are being adopted in all aspects of society and life.

Wireless networks are being implemented in all facets of business, school, public and private life. Schools of all levels use them to provide access to students for research and learning material, to provide access to research results for professors and students, and for class enrollment. Public places are implementing wireless networks so that visitors can access the internet while sitting in a park or reading in a library, for two examples. Individuals are even setting up their own wireless networks in their home so they can access the internet and their own computers via their TVs, tablet computers, phones, and audio devices.

Businesses may use wireless networks to run their operations. A large industrial complex that covers a large geographical area with multiple structures may require several APs distributed across the complex so that all devices, mobile or stationary, are connected to the network. Additionally, business are allowing their employees to bring and use their personal wireless devices to work and employees may have two or more devices connected to the network at any one time—one work issued, the other personal. On top of the employee devices, visitors to businesses may also be allowed to join the network to access the internet or retrieve information from their own network. The number of devices using wireless networks, especially for businesses, has increased dramatically and will continue to do so.

Yet, the number of devices may only be one factor relating to the level of usage a wireless network may experience. The programs and internet content being accessed over the network by the wireless devices may also affect the network. The programs and internet content require BW for their transmission through the network. Newer programs and video intensive internet content may consume large amounts of BW. Additionally, some devices or traffic on a wireless network may request a high quality of service (QoS) application, which may limit the amount of BW or other resources available for other users. QoS requests typically receive priority in their execution and possibly may require a reservation for a set amount of BW. Internet-telephony is a typical application that requires QoS and is being used by more devices when connected to wireless networks.

Network performance, thus, may be affected by the amount of usage because networks have a finite BW. As used herein, BW may refer to the throughput of the system or the rate of data transfer (e.g., in bits per second) within the network and may include both the BW in the wired portion of the network as well as the wireless BW available. In the wired portion of the network, the BW may be limited by the modulation scheme, path loss associated with the communication medium, and the average level of noise. In the wireless portion of the network, the amount of BW may be a function a number of factors, including the radio frequency (RF) used to transmit the wireless signals, the modulation and coding methods used for transmissions, the RF channel characteristics, and the level of interference. Typical wireless network frequencies may range from 2.4 Gigahertz (GHz) to 5 GHz and the modulation used may be orthogonal frequency-division multiplexing. Therefore, with the increase in the number of devices on a network and the BW hungry applications and content being accessed by the devices, the available network BW may quickly be consumed and become a point of network performance deterioration. In addition to bandwidth other QoS related parameters such as delay and jitter can cause significant degradation in performance over a wireless network.

A wireless network may require a system to manage and control the traffic within the network. The management and control of a network may involve several parameters for managing the wireless portion of the network, and the network may generate extra traffic for the management and control of the network. Most, if not all, the management and control traffic may consume BW in the wired portion of the network and some will also be wirelessly transmitted to and from connected devices. For example, the parameters of the wireless portion may include the assignment of channels to wireless devices. Wireless networks normally have a range of frequencies, or spectrum, available for use and that spectrum may be broken into channels. Each channel may be assigned to an individual connected device. The spectrum may also be analyzed for average usage and transmission collisions by the network. A collision may occur when two or more devices are attempting to simultaneously use the same channel. Other network management parameters may relate to the average power being transmitted by the APs and the wireless devices, resource allocation of network resources, and information from connected stations (STAs). User devices may also be referred to as STAs. The parameters discussed herein may only be a few of the parameters that are managed by a wireless network and are used for illustration purposes only. The illustrative use herein of specific parameters should not be construed to limit the application of the present disclosure to only the parameters discussed in detail.

Another aspect of a wireless network that requires increased management and control traffic arises due to the mobility of the STAs connected or joining the network, as well as the dynamic nature of the wireless channel. In some wireless networks, mobile STAs may not have much mobility due to the limited area of the wireless signal strength transmitted by an AR Wireless transmitters used by wireless networks may be limited in RF power by the government, which may limit the distance an AP may be able to broadcast signals. Thus, for organizations that may need to cover a large area with wireless connectivity, multiple APs may be required. In such a scenario, mobile STAs roaming around within the network may need to change the AP it is connected through if the signal strength begins to fade as the user moves around. Therefore, the network may need to know the location and movement of STAs with respect to the network's APs so that the STAs can be directed to switch APs, if necessary, to accommodate better resource management and enhance the spectral efficiency. In order to manage the mobile aspect of networks, management and/or control parameters specifically aimed at mobility may be utilized by a wireless network.

The control of the networks may include changing the parameters discussed above that affect the operation of the network. For example, a STA just joining the network may be instructed to communicate using a specific channel and to adjust the power it is using to transmit its signals. Through the use of management and/or control parameters, networks may be maintained to operate efficiently by controlling the transmission of data to and from STAs, for example. The wireless network may also require control and management to be sent to the backbone of the system over the wired portion of the network. In both instances, the transmission of management and/or control parameters may consume network BW, which may be needed by critical user applications.

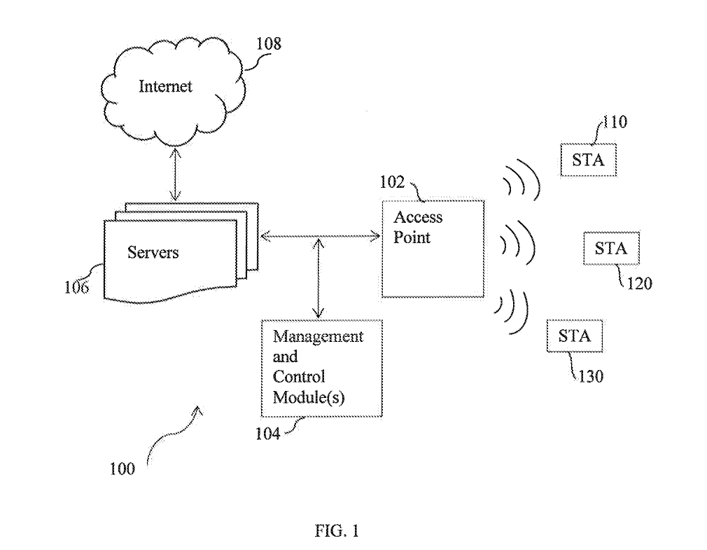

FIG. 1 illustrates an embodiment of a WLAN 100. The WLAN 100 may include an AP 102, a management and control module(s) (MCM) 104, multiple servers 106 connected to the internet 108, and STAs 110, 120, and 130. The three STAs 110, 120, and 130 may be wirelessly connected to the AP 102. Any number of STAs may be used in combination with the present disclosure. An STA may be a smart phone, cell phone, tablet computer, laptop computer, desktop computer, printer, or any other device that sends or receives data wirelessly. The WLAN 100 may represent an enterprise network at a business, university, or hospital, as examples.

The MCM 104 may be used to manage and/or control the network 100 by obtaining information regarding the management and/or control parameters discussed previously and by transmitting changes to those parameters to various parts of the network 100. The MCM 104 may transmit changes to the parameters to the AP 102, which may then be used by the AP or transmitted those changes to connected STAs 110, 120 and 130. For example, if the AP 102 transmits information about management parameters to the MCM 104 and the information shows that there has been a transmission collision event on a channel by STAs 110 and 130, then MCM 104 may change the channel assignment of STA 110, STA 130 or both. The changes to the channel assignment(s) may then be transmitted to the AP 102 by the MCM 104, which may then transmit the changes to STA 110, STA 130 or both. In this fashion, the network 100 through MCM 104 and AP 102 may be managed and controlled so that it functions properly and efficiently. Although illustrated as a single module, the MCM 104 may be implemented as two modules—a management module and a control module. The control module (or controller) may be responsible for parameters that need control over a relatively smaller time scale (e.g., real time or near real time), while the management module (or network management) may be responsible for parameters or issues that require relatively less time-critical control. For example in WLAN architectures real-time parameters may include Security Policies, QoS Policies/Queuing, scheduling, Radio Resource Management (RRM), and Mobility Management. Non-Real time parameters may include network management parameters, interference classifications, and any other data average over a relatively long period of time.

In a conventional wireless network, the management and/or control data may be collected and transmitted at set intervals. These intervals may be set at defined periods by the network's administrator or they may be dynamically set by the network itself depending on network traffic. At the end of these intervals, the network MCM 104 may transmit changes to the management and/or control parameters to AP 102, which may forward some of that information along to STAs 110, 120, and 130. In addition, the AP 102 may collect and transmit information regarding the management and/or control parameters to the MCM 104. Yet in a conventional network, AP 102 may not save the information transmitted to the MCM 104 between intervals. In each transmission, a full representation of each parameter may be transmitted. For example, suppose a parameter is represented at times t₁ and t₂ by parameter values α₁ and α₂, respectively. At about time t₁ a digital representation of α₁ may be transmitted, and at about time t₂ a digital representation of α₂ may be transmitted. These transmissions may not take advantage of possible correlations between α₁ and α₂ to reduce bandwidth.

As discussed above, wireless networks, such as network 100, are growing in number and size and may become a primary type of network used by many enterprises for their business needs. in such a scenario, the management and/or control of the network may become ever more critical. As evidence to how critical the management and/or control of wireless networks is becoming, two standards aimed at such ends are either under development or in the process of being implemented—namely IEEE 802.11k and 802.11v. IEEE 802.11k targeted at radio resource management defines and exposes radio and network information to facilitate the management and maintenance of a mobile WLAN. IEEE 802.11v targeted at wireless device management allows configuration of client devices while connected to wireless networks, where client devices would be STAs as discussed in this disclosure. However, as critical as the management and/or control of a WLAN are, the transmission of the management and/or control data may consume critical BW.

Thus, with the increase in devices connected to a wireless network, such as network 100, the BW hungry applications being accessed, and the requirement to manage and control the network, the finite BW available to the network may quickly be consumed. The dwindling BW available to a network may then need to be managed even more closely, yet this may require more management and'or control signals, which may involve even more BW. Therefore, a method to efficiently manage and control the wireless network while reducing the BW usage of the management and/or control traffic may be desired. However, this reduction should not compromise the management and/or control of the network for the sake of using less BW.

Disclosed herein are systems, apparatuses, and methods for efficiently managing a wireless network by reducing BW needed for control and/or management data transmitted within the wireless network infrastructure. The systems, apparatuses, and methods disclosed herein may be applied to reduce the BW needed for control data or management data or both. That is, the systems, methods, and apparatuses can achieve desired results regardless of whether applied to control data (or control traffic) or to management data (or management traffic). In recognition that differences between what may be referred to in the WLAN industry as “control” data and “management” date refers primarily to data related to control of a network in a general sense with the difference being primarily one of time scale, hereafter the term “control data” may refer generally to data related to control of a network and may include management data and/or control data as those terms are used in the WLAN industry. Similarly, “control parameters” may sometimes be used to refer to “management and/or control parameters.” The systems, apparatuses, and methods disclosed herein may generally apply to reduce bandwidth of control data, where “control” is used in a general sense. This implies, for example, that the MCM 104 may be hereafter referred to as a control module. One embodiment may involve transmitting only changes to control parameters to and from an AP and a control module of the wireless network instead of transmitting a full representation for each parameter. Maintaining a record of the parameters by all communicating devices, especially the APs, allows differentials of the parameters to be taken at the intervals. The differentials, then, would be the control data transmitted by the AP to a control module. In this way, the systems and methods disclosed herein may take advantage of correlations in parameter values by transmitting only changes in parameter values between one time instant and another time instant.

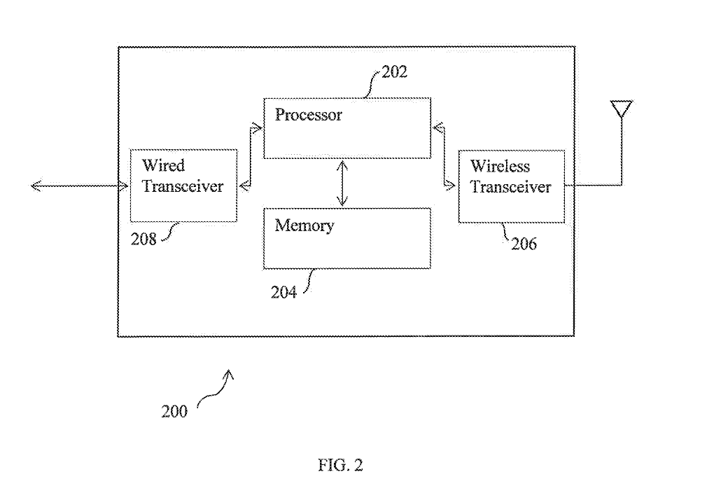

FIG. 2 illustrates an embodiment of a WLAN AP 200. AP 200 may include a processor 202, a memory 204, a wireless transceiver 206, and a wired transceiver 208. The processor 202 may be used to facilitate the transmission of data between servers or the internet and STAs, such as between servers 106 and STA 130. The memory 204 may be used as a buffer when transmitting Internet content or other traffic data to a connected STA, such as STA. 130, or it may be used to store control data, such as control data received from MCM 104. Wireless transceiver 206 may be used to transmit data to connected STAs, such as STAs 110, 120, and 130. Wireless transceiver 206 may also be used to receive requests from STAs. Lastly, wired transceiver 208 may be used to communicate with a backbone of the WLAN network. For example, wired transceiver 208 may communicate with one or more control module(s), such as MCM 104.

In accordance with various embodiments, AP 200 may be used by a wireless network, such as network 100, as a gateway to the network for wireless devices, such as STA 120. In this capacity. AP 200 may also receive requests to join the network from a STA that just entered the wireless range of AP 200. AP 200 may also be used to collect and retain in memory 204 information regarding the control of the network and information about each connected STA. As a repository of control data, AP 200 may transmit that information to STAs, to a control module, such as MCM 104, and may receive control updates from the same module.

The memory 204, in accordance with this embodiment, may contain a record of all control parameters used by AP 200 and the network, such as network 100. Each parameter being utilized by the network may have its own binary representation outlining the details of that parameter and each representation may be of varying lengths. For example, information. concerning spectrum interference events may be transmitted by a packet 10 symbols long, whereas a packet for transmitting average transmitted power may be only 4 symbols long. Another embodiment, however, may combine all the parameters into a single packet to be saved in the memory of an AP, such as memory 204 in AP 200, and transmitted to a control module.

At preset intervals, the control data may be collected by AP 200 then transmitted via wired transceiver 208 to a control module, such as MCM 104. However, instead of transmitting the full binary representation of each parameter, as is done conventionally, only changes in values of parameters may be transmitted. By only transmitting the changes, fewer bits may be transmitted for each parameter. If a parameter has not experienced any change since the prior interval, then no information concerning that parameter may be transmitted. By transmitting only changes or updates to the parameters or a subset of the parameters, less BW may be used for the transmission of control data.

For AP 200 to transmit the changes to the control data instead of a whole packet of data, it must compare the newly collected data to the control data that was saved from the last interval. Thus, in accordance with various embodiments, the AP 200 may collect the control data, compare it to the control data stored in the memory 204 from a previous interval, and then transmit only the changes, or differential between the two intervals. The changes may be transmitted to a control module, such as MCM 104, or it may be transmitted to other APs or to STAs, or to all of them. After the changes have been calculated and transmitted, the entire set of data for each parameter may then be saved to the memory 204. The memory 204 may over-write the data from the previous interval or it may retain all the data for a set number of intervals before over-writing it.

For example, and in accordance with various embodiments, optimization of the exchange of spectral interference data may be achieved using this disclosure. In this embodiment, a snapshot of the average spectral data may be taken or collected by AP 200. The average spectral data may show the occurrence of any collisions or interfering signals and may be an average of a static time window defined by the reporting interval discussed above. The time window may also be a sliding time window so that an average of the spectral data is obtained between intervals. If the embodiment is using a static window, then the average taken at the end of the interval may represent a current value. The current value may then be compared by processor 202 to the average from the previous interval stored in the memory 204. The differential between the two averages may then be transmitted by AP 200 to a control module, such as MCM 104.

A fast Fourier transform (FFT) may be used to obtain a snapshot of the spectrum usage. As understood by one of skill in the art, a transceiver, such as transceiver 206, may observe characteristics of a radio frequency spectrum via an antenna. The FFT may be used to sample the antenna output to obtain data regarding spectrum usage. The FFT may be computed in the transceiver or using a processor, such as processor 202, coupled to the transceiver.

The FFT may be an N-point FFT in which each of the N FFT samples may be represented by k bits, where N and k are positive integers. Thus, the total number of bits required for a spectrum snapshot may be N·k bits. In a conventional AP, a total of N·k bits may be reported to an MCM for each snapshot.

Suppose that a previous value of the snapshot is reported to an MCM using N·k bits and a current value of the spectrum snapshot is computed, also using N·k bits. The current values of the FFT samples may be compared to the corresponding previous values of the FFT samples and a difference computed for each sample. In each time period only the differential values may be communicated thereby conserving BW.

For example, suppose each FFT spectral sample is represented by 10 bits. Then the differential between the current and prior FFT sample may be represented by less than 10 bits. In such an instance, fewer than 10 bits may be transmitted by AP 200 instead of the entire 10 bits for each sample. The number of bits being transmitted for each sample may be fixed at 2, for example, or may be adaptive to the environment. If the number of bits used is adaptive, then the number may be estimated for the variance of samples computed through statistical analysis of the differential between the two FFTs.

The first time a parameter is transmitted the full representation of the parameter may be transmitted. Subsequent transmissions may comprise differences in the parameter value as a difference between a current value and a previous value. Suppose α[n] is a value of a parameter at the nth time instant or averaged over the nth time interval, where n≧1. The value α[1] may be transmitted first. Thereafter, values of Δ[n] may be transmitted, where Δ[n]=α[n]−α[n−1] for n≧2.

For another example, optimization of the control traffic associated with parameters defined by IEEE 802.11k and 802.11v standards may be realized by implementing embodiments in accordance with this disclosure. For these two standards, each STA is associated with a unique identity and an AP that the STA is using maintains an up-to-date snapshot of all the information received from that STA. In regards to IEEE 802.11k, all the information may refer to movement of the STA with respect to the AP, specifically to determine if the STA is moving away from the AP. If the AP determines the STA is moving away from the AP, then the STA is informed to prepare to switch to a new AP, if there is one associated with the network. The STA then requests a list of any nearby APs and the AP supplies the list. Based on the list, the STA then switches to the best AP.

Thus, to continue the example, the AP, such as AP 200, may maintain the movement information concerning all STAs connected to it and a list of all available alternative APs. The AP is also communicating this information to a control module, such as MCM 104. However, instead of communicating the entire record, or packet of information, at each interval, only changes to the information may be transmitted to a control module. This same process may also be applied to information regarding IEEE 802.11v standard, For IEEE 802.11v, this info may include network topology, the RF environment, making each STA network aware and facilitating overall improvement of the wireless network.

In the context of the control traffic as defined by IEEE standards 802.11k and 802.11v, when a new STA joins a network, the complete set of information in terms of the two standards are transmitted to a control module. Additionally, if the information regarding a STA is unchanged for an extended amount of time, then basic information about the STA may be transmitted to indicate to a control module that the STA is still active.

A control module of a wireless network, such as MCM 104, may receive control data transmitted by AP 200. Since the MCM 104 may be receiving only changes to the parameters instead of complete packets, it may need to complete some comparisons to update the information it may already have saved. Alternatively, the MCM 104 may simply update the parameters with the changes without needing to make any comparisons. Regardless of the method used to update the control parameters, the transmission of changes instead of a full representation for each parameter may save BW while maintaining effective management of the wireless network.

The MCM 104 may also utilize the same technique when transmitting updates to control parameters to APs and STAs. The MCM 104 may change the control parameters then compare them to what was sent at a previous interval. The MCM 104 may then transmit only the differences or changes to those parameters based on the comparison. In other embodiments, the MCM 104 may transmit the changes without comparing the parameter packets. In either embodiment, BW should be conserved since less information may be transmitted by the MCM 104 to APs and STAs.

The processor 202 may be implemented as one or more chips, cores e.g., a multi-core processor), field-programmable gate arrays (FPGAs), application specific integrated circuits (ASICs), and/or digital signal processors (DSPs). The memory 204 may include a combination of one or more of secondary storage, read only memory (ROM), and/or random access memory (RAM). The secondary storage may comprise one or more disk drives or tape drives and may be used for non-volatile storage of data and as an over-flow data storage device if RAM is not large enough to hold all working data. Secondary storage may be used to store programs that are loaded into RAM when such programs are selected for execution. The ROM may be used to store instructions and perhaps data that are read during program execution. ROM may be a non-volatile memory device that typically has a small memory capacity relative to the larger memory capacity of secondary storage. The RAM may be used to store volatile data and perhaps to store instructions. Access to ROM and RAM is typically faster than to secondary storage.

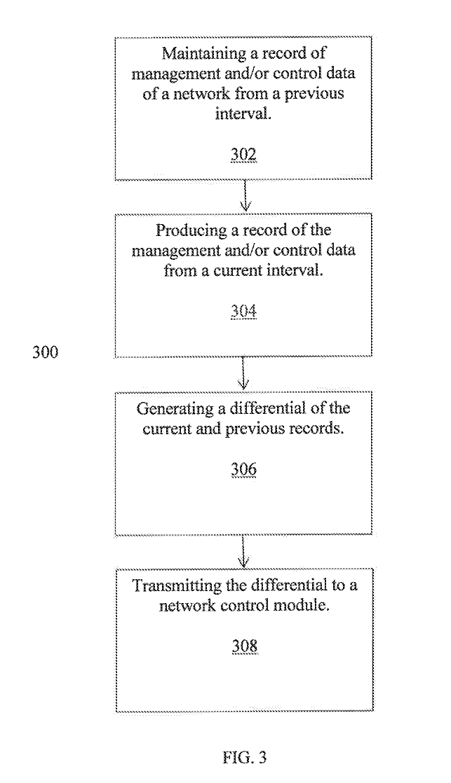

FIG. 3 illustrates an embodiment of a method 300 for optimizing the transmission of network management and/or control data, for example performed by AP 200 in accordance with various embodiments. Method 300 begins in block 302 with maintaining a record of management and/or control data of a network from a previous interval. The record may be stored in a memory, such as memory 204. Method 300 continues in block 304 with producing a record of the management and/or control data from a current interval. For example, if the management and/or control data comprises FFT samples, an FFT may be performed. Method 300 continues in block 306 with generating a differential of the current and previous records. The differential may be computed in a processor, such as processor 202. Method 300 ends in block 308 with transmitting the differential to a network control module. The transmission may be performed using a transceiver, such as wired transceiver 208.

It is understood that by programming and/or loading executable instructions onto the AP 200, at least one of the processor 202 and the memory 204 are changed, transforming the AP 200 in part into a particular machine or apparatus having the novel functionality taught by the present disclosure. For example, the AP 200 may be configured to implement the method 300. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new AS IC is a particular machine or apparatus, likewise a computer that has been programmed and/or loaded with executable instructions may be viewed as a particular machine or apparatus.

As discussed, by an AP transmitting only the differential of control data, BW may be conserved by the network. The conserved network may then be utilized by more important transmissions of user data or critical instructions for security, video-on-demand applications. Additionally, by transmitting only changes in control data, redundant management and/or control traffic may be eliminated. Therefore, by conserving BW and maintaining efficient management and/or control of the wireless network, a reduction of BW usage may be realized.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(R₁), wherein k is a variable ranging from 1 percent to 100 percent with a 1 percent increment, i.e., k is 1 percent, 2 percent, 3 percent, 4 percent, 7 percent, . . . , 70 percent, 71 percent, 72 percent, . . . , 97 percent, 96 percent, 97 percent, 98 percent, 99 percent, or 100 percent. Moreover, any numerical range defined by two R numbers as defined in the above is also specifically disclosed. The use of the term “about” means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. An apparatus for the transmission of control traffic in a network, comprising:
a memory configured to store a first record of control data from a previous interval; and
a processor coupled to the memory, wherein the processor is configured to:
retrieve the first record;
receive a second record of the network control data for a current interval; and
generate a differential of the first and second records.

2. The apparatus of claim 1 wherein a number of information bits used to represent the differential is less than a number of information bits used to represent the second record.

3. The apparatus of claim 1, further comprising a transceiver configured to transmit the differential to a control module.

4. The apparatus of claim 1 wherein the control data includes average spectral usage information.

5. The apparatus of claim 1, wherein the control data includes information about spectral interference events.

6. The apparatus of claim 1, wherein a complete record of control data regarding a station that just joined the network is transmitted.

7. The apparatus of claim 1, wherein the control data includes average transmitted power information.

8. The apparatus of claim 1, wherein the control data includes resource allocation information.

9. The apparatus of claim 1, wherein the transceiver is a wired transceiver, wherein the apparatus further comprises a wireless transceiver configured to couple to a wireless station, and wherein the apparatus is an access point (AP) configured to act as a gateway to a wired network for the wireless station.

10. A method for transmitting management or control data in a network, comprising:
maintaining a record of control data of a network from a previous interval;
producing a record of the control data from a current interval;
generating a differential of the current and previous records; and
transmitting the differential to a control module.

11. The method of claim 10, wherein a number of information bits used to represent the differential is less than a number of information bits used to represent the current record.

12. The method of claim 10, wherein the complete record of control data is transmitted for a station that just joined the network.

13. The method of claim 10, wherein the control data contains information concerning average spectral usage of the network.

14. The method of claim 10, wherein the control data contains information concerning spectral interference events.

15. The method of claim 10, wherein control data includes information concerning average transmitted power by the network module and by the station.

16. The method of claim 10, wherein the control data contains basic information about stations that have not had changes to their control data in a predetermined number of intervals.

17. An apparatus for reducing redundancy in the transmission of control parameters of a network, comprising:
a processor configured to receive a first record of a control parameter, wherein the first record indicates a change in the parameter over a current time interval; and
a memory coupled to the processor configured to store records.

18. The apparatus of claim 17, Wherein the processor is further configured to compare the first record to a previous record from a prior interval, where the previous record is stored in the memory.

19. The apparatus of claim 17, wherein the processor is further configured to modify the previous record based on the comparison of the first record to the previous record, wherein the modified previous record is stored as a current record.

20. The apparatus of claim 17, wherein the processor is further configured to store the current record in the memory.

21. The apparatus of claim 17, wherein the current record from the current time interval will be the prior record after a subsequent time interval.
